(19) United States
(12) Patent Application Publication
(10) Pub. No.: US 2008/0168929 A1
(43) Pub. Date: Jul. 17, 2008

(54) Trailer hitch and detachable winch mounting assembly

(75) Inventor: William E. Thompson, Buena Park, CA (US)

Correspondence Address: LEONARD TACHNER, A PROFESSIONAL LAW;CORPORATION, 17961 SKY PARK CIRCLE, SUITE 38-E, IRVINE, CA, 92614, US

(73) Assignee: Barbarian Industries, L.L.C.

(21) Appl. No.: 11/653,810

(22) Filed: Jan. 16, 2007

(51) Int. Cl. F16M 11/18

(52) U.S. Cl. 108/44

(57) ABSTRACT

A winch mounting assembly for attachment to a trailer hitch receiver of a vehicle enables simultaneous use of a stowable winch and attachment of a trailer. The assembly comprises a horizontal extension tube and a vertical tube, the latter receiving a removable winch platform from which a mounting post extends.

### BACKGROUND OF THE INVENTION

1. Field of the Invention

The present invention relates to a detachable winch mounting assembly that provides unfettered removal, installation and simultaneous use of the winch and a motor vehicle trailer.

2. Background Art

Loading and unloading of motor vehicles on a trailer platform can be hazardous to property as well as personnel. Motor vehicle trailers equipped with electric winches are expensive and subject the winch equipment to possible theft or premature failure due to exposure to the elements. Removable winch cradles are available; however, they utilize the receiver intended for the trailer hitch. Therefore, the user can attach a winch or a trailer but not both at the same time. After-market, permanently mounted winch platforms are available for many vehicles, but they alter the vehicle appearance and usually require professional installation at a considerable cost. Most winch platforms are designed for front of vehicle application while rear-mounted winch platforms frequently interfere with access and use of the vehicle's rear storage area. Permanently mounted winch platforms must be sold with the vehicle or professionally removed at considerable expense.

### SUMMARY OF THE INVENTION

A detachable winch assembly requires no alteration of the tow vehicle or trailer. It can be installed on any suitable vehicle equipped with a draw bar-type receiver and coupled with virtually any car trailer or car dolly. The perpendicularly mounted square steel portal provides independent and unfettered access to the winch device and the trailer hitch ball. Therefore, the trailer remains securely attached to the two-vehicle while the non-operable motor vehicle is winched onto the trailer or car dolly. Once the vehicle is secured, the winch can be removed and safely stored in the tow vehicle. This device is appropriate for off-road front of vehicle winch applications as well, if the vehicle is so equipped.

### BRIEF DESCRIPTION OF THE DRAWINGS

The various embodiments, features and advances of the present invention will be understood more completely hereinafter as a result of a detailed description thereof in which reference will be made to the following drawings:

FIG. 1 is a three-dimensional view of a preferred embodiment of the invention showing the assembly with a winch mounted thereon and trailer connected thereto;

FIG. 2 is a side perspective view of the assembly of FIG. 1;

FIG. 3 is a side view of the lower portion of the assembly; and

FIG. 4 is a perspective view of the upper portion of the assembly.

### DETAILED DESCRIPTION OF THE INVENTION

The apparatus of the present invention consists of welded square steel tubing of a size compatible with draw bar-type trailer hitch receivers common on many new motor vehicles and after-market tow-hitch devices. The assembly is configured with a vertical steel tube welded to a horizontal steel tube that slides into the vehicle's draw bar-type receiver. The opposite end of the horizontal tube provides a portal that accommodates a conventional draw bar trailer tongue and ball. The vertical steel tube is fortified with a ¼ inch plate steel gusset. This tube provides a portal for ¼ inch thick steel plate designed to accommodate many portable electric winch designs. The plate is welded to a square steel tube reinforced with a steel collar and ¼ inch plate steel gussets.

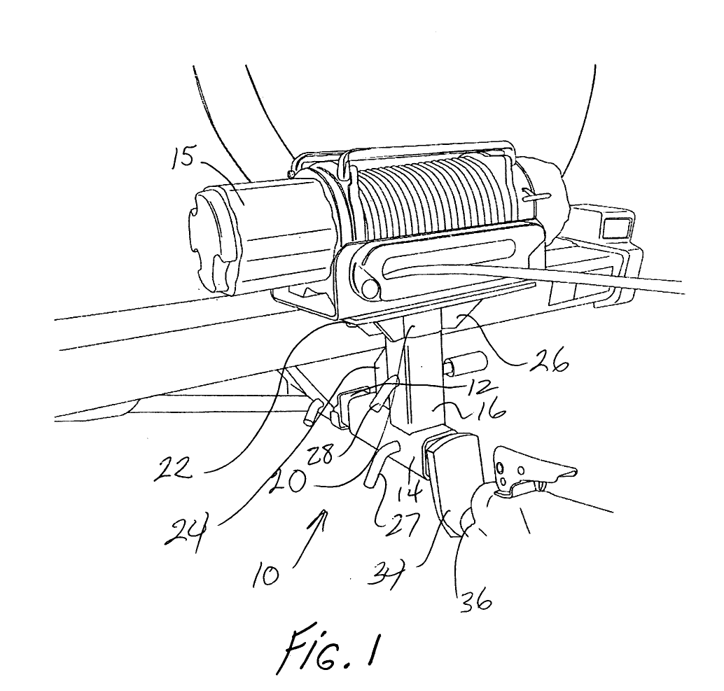

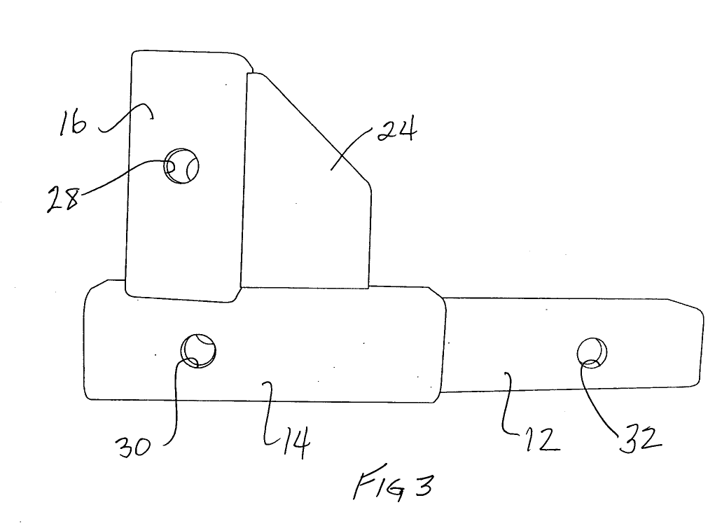

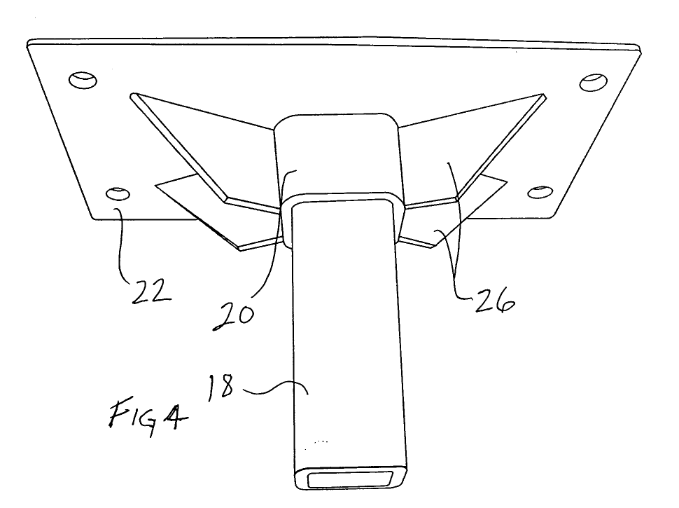

As shown in the accompanying drawings of FIGS. 1-4, the detachable winch mounting assembly is comprised of two separate detachable units. One unit is the winch mounting plate 22. A length of steel tube 18 is inserted into the two (2) inch long collar 20 and recessed ½ inch to allow room for a welding bead. Once welded, the mounting post 18 and collar 20 are then centered on the mounting plate with gussets 26 radiating from the center of the plate to the winch mounting holes 17. These units are butt-welded in place. A hitch pin 25 attaching hole 30 is centered and placed for docking of the accessory.

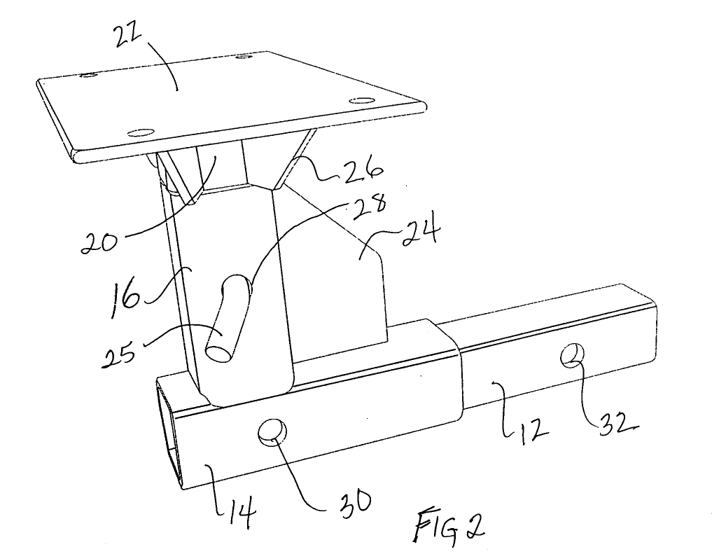

A second unit consists of tubes 12,14,16 and gusset 24. Tubes 12 and 14 are welded together in an end-weld fashion as indicated in FIG. 2. Steel tube 16 is attached to tube 14 approximately two inches from the end and at right angles. They are joined with a butt-weld. Gusset 24 is centered on steel tubes 14 and 16 and surface welded into place. Horizontal tube 12 is preferably nine inches long. Tube 12 is inserted into horizontal tube 14 leaving an adequate length of tube 12 to couple with the two-vehicle bar-type receiver. Hitch pin attaching holes 28, 30 and 32 are centered and placed for docking of the accessory. The detachable winch mounting assembly is constructed from lengths of square steel tube 14, 16 and 20 with ¼ inch wall thickness and I.D. of 2 inches. The winch mounting plate 22 is ¼ inch plate steel preferably having a width of 10 inches by a length of 8 inches. Gusset 24 and 16 are of ¼ inch plate steel and are provided for structural strength.

Having thus disclosed a preferred embodiment of the invention, it will now be apparent that variations and modifications thereof may be readily perceived by those of skill in the relevant art having the benefit of the Applicant's teaching herein. Accordingly, the scope hereof is to be limited only by the appended claims and their equivalents.

I claim:

1. A winch mounting assembly for attachment to a trailer hitch receiver of a vehicle; the assembly comprising:
at least one horizontal tube for attachment to a trailer hitch receiver for extending said receiver beyond said vehicle;
a vertical tube affixed to said at least one horizontal tube and extending upwardly therefrom substantially perpendicular thereto;
a planar platform for supporting a winch on an upper surface of said platform and having a mounting post extending from a lower surface of said platform;
said mounting post being configured for removably mating co-extensively with said vertical tube.

2. The assembly recited in claim 1 wherein said mounting post and said vertical tube each have aligned holes when mated;
said assembly further comprising a removable pin for insertion through said aligned holes for securing said mounting post to said vertical tube.

3. The assembly recited in claim 1 wherein said at least one horizontal tube has an open portal for receiving a tongue and ball apparatus for attaching a trailer to said vehicle.

4. The assembly recited in claim 1 further comprising a gusset further securing the vertical tube to the at least one horizontal tube.

5. The assembly recited in claim 1 further comprising at least one gusset further securing the mounting post of the lower surface of said platform.

6. The assembly recited in claim 1 wherein said at least one horizontal tube comprises a pair of horizontal tubes in a co-linear, telescoped arrangement.

7. An assembly for attachment to a trailer hitch receiver tube of a vehicle to enable mounting of a winch and attachment of a trailer to said vehicle at the same time; the assembly comprising:
at least one horizontal tube for attachment to a trailer hitch receiver for extending said receiver beyond said vehicle;
a vertical tube affixed to said at least one horizontal tube and extending upwardly therefrom substantially perpendicular thereto;
a planar platform for supporting a winch on an upper surface of said platform and having a mounting post extending from a lower surface of said platform.

8. The assembly recited in claim 7 wherein said mounting post and said vertical tube each have aligned holes when mated;
said assembly further comprising a removable pin for insertion through said aligned holes for securing said mounting post to said vertical tube.

9. The assembly recited in claim 7 wherein said at least one horizontal tube has an open portal for receiving a tongue and ball apparatus for attaching a trailer to said vehicle.

10. The assembly recited in claim 7 further comprising a gusset further securing the vertical tube to the at least one horizontal tube.

11. The assembly recited in claim 7 further comprising at least one gusset further securing the mounting post of the lower surface of said platform.

12. The assembly recited in claim 7 wherein said at least one horizontal tube comprises a pair of horizontal tubes in a co-linear, telescoped arrangement.
